(19) United States
(12) Patent Application Publication
(10) Pub. No.: US 2003/0234025 A1
(43) Pub. Date: Dec. 25, 2003

(54) Filter devices for removing toxic substance from gas

(75) Inventor: Hsin-Shiu Chuang, Taoyuan (TW)

Correspondence Address: MERCHANT & GOULD PC, P.O. BOX 2903, MINNEAPOLIS, MN, 55402-0903, US

(73) Assignee: ROYAL DYNESTY TECH.CO., LTD, Taoyuan City (TW)

(21) Appl. No.: 10/176,559

(22) Filed: Jun. 21, 2002

(51) Int. Cl. B31C 13/00

(52) U.S. Cl. 131/342; 131/202

(57) ABSTRACT

The present invention relates to a new use of Pini Resina for removing toxic substances from a gas. In particular, the invention provides a cigarette filter comprising a filter layer containing Pini Resina, which can remove the toxic substances derived from a burning cigarette.

### FIELD OF THE INVENTION

The present invention relates to a new use of Pini Resina for removing toxic substances from a gas. In particular, the invention relates to a cigarette filer comprising a filter layer containing Pini Resina for removing toxic substances from a gas.

### BACKGROUND OF THE INVENTION

Pini Resina is a Pinus plant of Pinaceae and can be used to make healing ointments. Persons skilled in the art can appreciate the conventional efficacies of Pini Resina according to several traditional Chinese Pharmacopoeias, such as “Compendium of Materia Medica” written by Li Shi Zhen. Commercial Pini Resina products are available in the local market.

It is known that a gas produced from a chemical reaction, exhaust from cars or motors, or cigarette smoke contain many toxic and carcinogenic substances (Zuccaro P. et al, 1993, J. Chromatogr, November 24:621 and Manabe S et al, 1991, Oct 12(10): 1945-7). Many studies suggested that benzene ring-containing compounds isolated from the cigarette smoke might be carcinogenic (Risner and Cash, 1990, J. Chromatogr. Sci. May 28(5): 239-44). To prevent the inhalation of the toxic substances, people use filter devices, such as a cigarette filter positioned between the burning cigarette and the smoker, an air cleaner or a mask containing activated charcoal, to prevent the toxic substances from entering into the bodies. However, the conventional filter devices are not effective to remove the toxic compounds. For instance, the conventional cigarette filter made of cellulose acetate, with or without activated charcoal, is ineffective in reducing the amount of toxic and carcinogenic compounds reaching the smoker. Therefore, there is a need for an improved filter device for removing toxic and hazard compounds from a gas.

### SUMMARY OF THE INVENTION

One object of the invention is to provide a composition comprising Pini Resina for removing toxic compounds from a gas. The composition of the invention may be provided in combination with a filter advice.

Another object of the invention is to provide a filter device for removing toxic substances from a gas, comprising a filter layer containing Pini Resina and a shell.

Still another object of the invention is to provide a process for preparing a filter device for removing toxic substances from a gas, comprising the steps of:

(a) heating and dissolving Pini Resina to produce an oil product of Pini Resina;

(b) wetting a porous substrate with the oil product of Pini Resina;

(c) drying the porous substrate such that the oil product is dispersed on or in the porous substrate; and

(d) incorporating the porous substrate containing Pini Resina into the filter layer of the filter device.

The invention also provides a process for preparing a filter device for removing toxic substances from a gas, comprising the steps of:

(a) heating and dissolving Pini Resina to produce an oil product of Pini Resina;

(b) mixing the oil product of Pini Resina with an activated charcoal to form a mixture;

(c) cooling the mixture down to room temperature to form a solid;

(d) grinding the solid and incorporating the ground solid into a porous substrate to form a filter layer; and

(e) Fixing the filter layer to the filter device.

The invention further provides a process for removing toxic substances from a gas comprising the steps of providing the filter device of the invention and allowing a gas comprising toxic substances to pass through the filter layer containing Pini Resina of the filter device.

### BRIEF DESCRIPTION OF THE DRAWINGS

FIG. 1A illustrates the HPLC profile of the smoke condensate passing through an empty cigarette filter holder (control).

FIG. 1B illustrates the HPLC profile of the smoke condensate passing through a cigarette filter containing charcoal (charcoal filter).

FIG. 1C illustrates the HPLC profile of the smoke condensate passing through the cigarette filter of the invention containing Pini Resina mixed with an activated charcoal (bio-charcoal filter).

### DETAILED DESCRIPTION OF THE INVENTION

The invention is directed to a new use of Pini Resina for removing toxic substances from a gas. Pini Resina is a conventional Chinese herb which can be used in making healing ointments. Persons skilled in the art can appreciate the conventional efficacies and preparations of Pini Resina according to several traditional Chinese Pharmacopoeias, such as “Compendium of Materia Medica” written by Li Shi Zhen. According to the Chinese Pharmacopoeias, no prior art discloses such uses of Pini Resina for removing toxic substances from a gas.

The primary aspect of the present is to provide a composition comprising Pini Resina for removing toxic substances from a gas. The composition of the invention can be provided in a filter advice. In particular, the composition of the invention can be provided in a cigarette smoke filter to remove the toxic substances produced from a burning cigarette, such as benzene ring-containing compounds, thereby the toxic compounds inhaled by the smokers can be reduced and thus a healthy condition is maintained. Preferably, the composition of the invention can further comprise a conventional ingredient, such as an activated charcoal or pyroglutamate sodium as described in the International Patent Application WO 98/157197 incorporated herein as reference, which aids in the removal of toxic substances from a gas. Persons killed in the art can formulate the composition of the invention in a proper ratio depending on their need.

For instance, Pini Resina is present in an amount of from about 1% to 99%, preferably about 10%, more preferably about 25% and most preferably about 50%, by weight of the composition of the invention. In particular, the composition of the invention can remove the carcinogenic compounds, such as phenolic and benzoic compounds, produced from a burning cigarette. The composition of the invention can be provided in other filter devices, such as a mask and an air cleaner, to remove the toxic substances from the air.

In another respect, the invention provides a filter device for removing toxic substances form a gas, comprising a filter layer containing Pini Resina and a shell. The term “filter device” used herein refers to any devices for filtrating toxic substances from a gas, such as a cigarette filter, mask or air cleaner. The term “filter layer” used herein refers to an element, provided in a filter device, containing an active ingredient for filtrating toxic substances from a gas. The term “shell” used herein refers to the portions, other than a filter layer, of a filter device.

The filter layer of the filter device of the invention contains Pini Resina which is dispersed on or in a porous substrate. The term “porous substance” used herein refers to any material suitable for use in a filter layer of a filter device, such as cellulose fiber, cotton, paper or polyester. The Pini Resina of the invention can further mixed with a known active ingredient, such as an active charcoal, which aids in the removal of toxic substances from a gas. In an embodiment of the invention, the Pini Resina is mixed with an active charcoal in a ratio of 1:20, preferably 1:5, more preferably 1:3 and most preferably 1:1. The filter device of the invention can remove toxic substances, such as exhaust of cars and motors or the hazard compounds produced from a chemical reaction. In a preferred embodiment, the filter device of the invention is a cigarette smoke filter which can remove the toxic compounds, such as phenolic or benzoic compounds, produced from a burning cigarette, to prevent the inhalation of such compounds by the smokers and thus a healthy condition is maintained.

According to the invention, persons skilled in the art can prepare the filter device of the invention in any manner. Accordingly, in another aspect, the invention provides a process for preparing a filter device for removing toxic substances from a gas, comprising the steps of: (a) heating and dissolving Pini Resina to produce an oil product of Pini Resina; (b) wetting a porous substrate with the oil product of Pini Resina; (c) drying the porous substrate such that the oil product is dispersed on or in the porous substrate; and (d) incorporating the porous substrate containing Pini Resina into a filter layer of the filter device. Preferably, the Pini Resina is heated and dissolved at a temperature from 600° C. to 900° C., more preferably 650° C. to 750° C., and optionally mixed with a known active ingredient, such as an activated charcoal, which aids in removal of toxic substances from a gas. Persons skilled in the art can mix the Pini Resina with the known active ingredient in a proper ratio depending on their need. In an embodiment of the invention, the Pini Resina is mixed with an activated charcoal in a ratio of 20:1, preferably 5:1, more preferably 3:1 and most preferably 1:1. WO 98/15197 and U.S. Pat. No. 5,829,449 are incorporated herein for reference.

The invention further provides a process for preparing a filter device for removing toxic substances from a gas, comprising the steps of: (a) heating and dissolving Pini Resina to produce an oil product of Pini Resina ; (b) mixing the oil product of Pini Resina with an activated charcoal to form a mixture; (c) cooling the mixture at room temperature to form a solid; (d) grinding the solid and incorporating the grinded solid into a porous substrate to form a filter layer; and (e) fixing the filter layer to the filter device. Preferably, the Pini Resina is heated and dissolved at a temperature from 600° C. to 900° C., more preferably 650° C. to 750° C. Person skilled in the art can mix the Pini Resina with an activated charcoal in a proper ratio depending on their needs. In an embodiment of the invention, the Pini Resina is mixed with an activated charcoal in a ratio of 20:1, preferably 5:1, more preferably 3:1 and most preferably 1:1. In particular, the filter layer of the invention can be used to prepare any filter devices, such as a cigarette filter, mask or sir cleaner, for removing toxic substances from a gas.

### EXAMPLES

The present invention will become apparent with reference to the examples below. The examples described below are given by way of illustration only and are not intended to be any limitation to the present invention.

Preparation of the Filter Device of the Invention

(1) Cigarette filter containing Pini Resina

A commercial Pini Resina was heated and dissolved at a temperature of 700° C. to form an oil product of Pini Resina. Cellulose acetate was wetted with the oil product of Pini Resina. The cellulose acetate was dried such that the oil product of Pini Resina was dispersed on or in the cellulose acetate, and then incorporated into a filter layer of a cigarette filter.

(2) Cigarette filter containing Pini Resina and an activated charcoal

A commercial Pini Resina was heated and dissolved at a temperature of 700° C. to form an oil product of Pini Resina. The oil product of Pini Resina was mixed with an activated charcoal in a ratio of 1:1 and cooled down to room temperature to form a solid. The solid was then ground and the ground solid was combined with a cellulose acetate to form a filter layer. Finally, the filter layer was affixed to a cigarette filter.

Comparable Analysis of the Smoke Passing Through the Filter Device of the Invention

A Long-Life cigarette, a commercial and popular cigarette in the ROC (Taiwan), was used to evaluate the efficacy of the filter device of the invention. Smoke derived from the Long-Life cigarette passed through an empty cigarette filter holder (control), a cigarette filter containing charcoal (Charcoal filter) and the cigarette filter of the invention containing Pini Resina mixed with an activated charcoal (bio-Charcoal filter), respectively, by a vaccum at a flow rate of 2 L/min. Then, the smoke collection procedure was performed on ice. The resulting smoke condensate was dissolved in an organic solvent, containing 29.5% CAN, 19.5% iso-propanol, 1% acetic acid and 49% H₂O ; or extracted by 10 ml of a water phase solution, consisting of one portion of (A) 1% acetic acid in water and one portion of (B) 1% acetic acid in a solution of 2-propanol and acetonitrile at a ratio of 2:3.

The organic extract was examined by optical density detection at 254 nm. Many hazardous benzene ring-containing compounds, such as benzoic and phenolic compounds, can be detected by OD 254 nm. As shown in the following Table 1, the readings of OD 254 in the control and charcoal filter groups were very similar, whereas notably the bio-charcoal filter significantly reduced the O.D. 254 component.

TABLE 1

| | Control | charcoal filter | bio-charcoal filter |
|---|---|---|---|
| O.D. 254 | 0.0406 | 0.0407 | 0.0225 |

In addition, 50 μl of the water phase solution was analyzed by reverse-phased HPLC 5C 18 MS column using the following condition:

| | |
|---|---|
| Column: | 5C18 MS |
| Flow rate: | 1.0 ml/min |
| Detection: | UV detector 254 nm |
| Gradient: | From 100% Solution A to 100% Solution B in 30 min |
| | Solution A: 1% acetic acid in water |
| | Solution B: 1% acetic acid in a solution of 2-propanol |
| | and acetonitrile (2-propanol: acetonitrile = 2:3) |

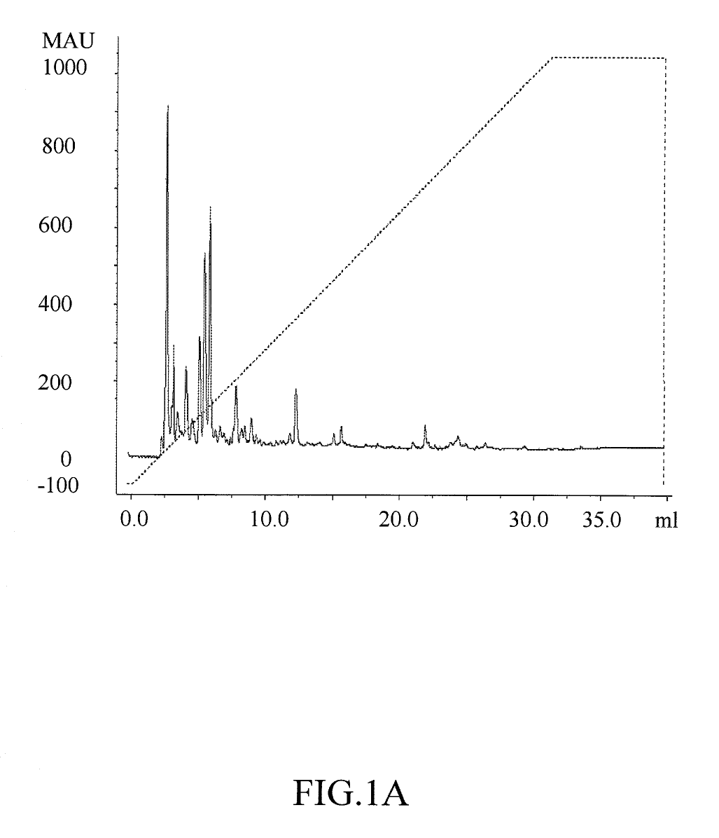

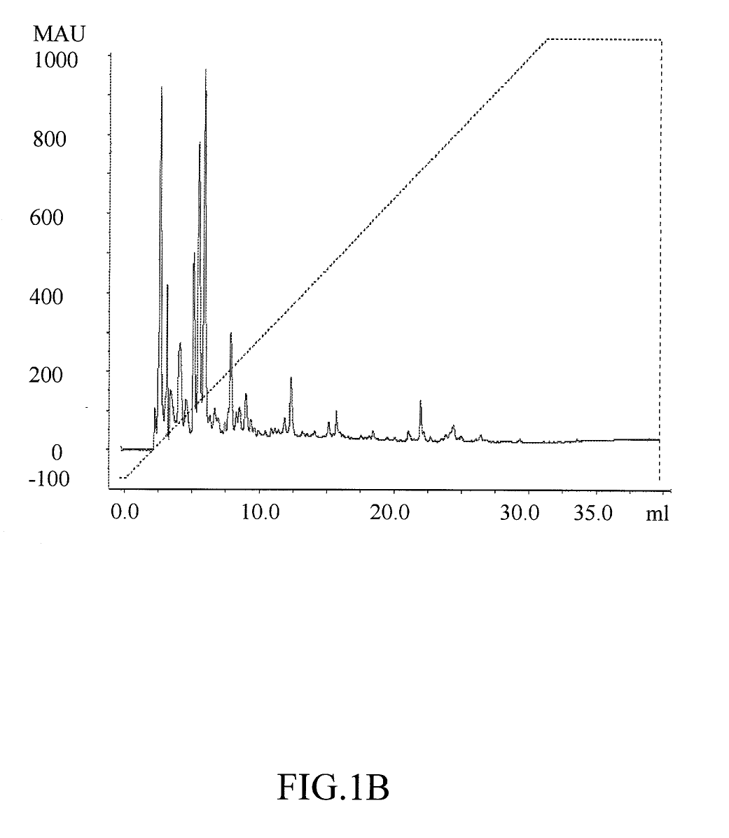

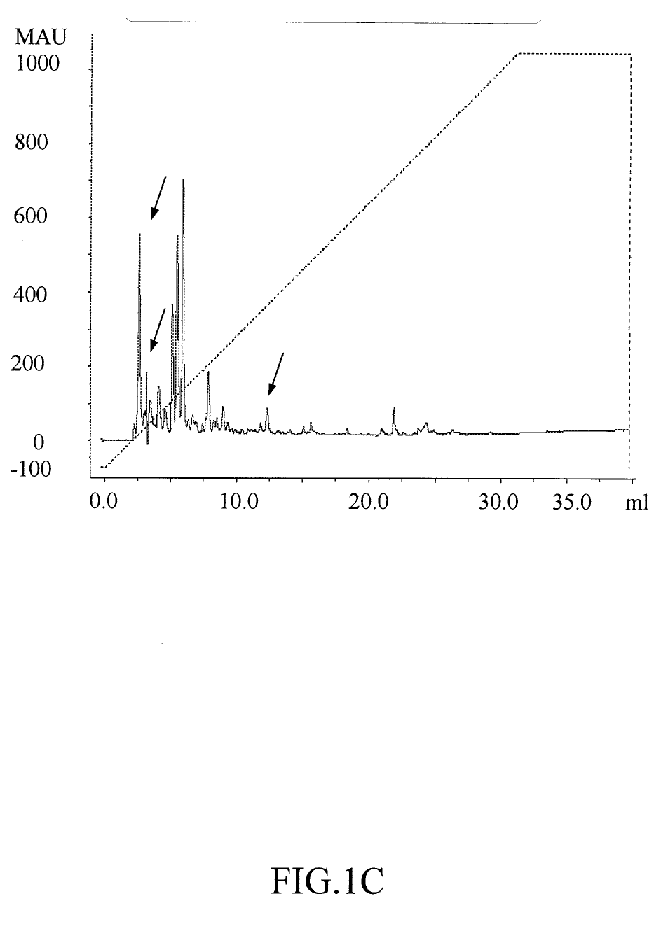

The HPLC profiles are illustrated in FIG. 1. As shown in FIG. 1, the HPLC profile of the smoke condensate in the control (FIG. 1A) and the charcoal filter (FIG. 1B) groups were very similar, containing several well-known benzoic compounds (Haugen and Stamoudis, 1986, Environ Res, December 41(2): 400-19). On the other hand, the bio-charcoal filter was noted to have significantly modulated the contents of the smoke condensate when compared with either control or charcoal filter group. There were at least three OD 254 peaks that were significantly reduced by the addition of Pini Resina to the filter, suggesting that Pini Resina could modulate benzoic compounds of cigarette smoke. Our results indicate a significant change in the composition of the smoke condensate when the Pini Resina was added to the charcoal-based cigarette filter compared with the charcoal filter along.

What is claimed is:

1. A composition provided in a filter device comprising Pini Resina for removing toxic compounds from gas.

2. The composition of claim 1, further comprising an active ingredient which aids in the removal of toxic substances from a gas.

3. The composition of claim 1, wherein the active ingredient is an activated charcoal.

4. The composition of claim 1, wherein the toxic compounds comprise benzene ring-containing compounds.

5. The composition of claim 4, wherein the benzene ring-containing compounds comprise benzoic or phenolic compounds.

6. The composition of claim 1, wherein the filter advice is a cigarette smoke filer, a mask or an air cleaner.

7. The composition of claim 1, wherein the gas is a smoke produced from a burning cigarette, exhaust from cars or motors or a toxic gas produced from a chemical reaction.

8. A filter device for removing toxic compounds from a gas, comprising a filter layer containing Pini Resina and a shell.

9. The filter device of claim 8, wherein the Pini Resina is further mixed with an active ingredient which aids in the removal of toxic substances from a gas.

10. The filter device of claim 9, wherein the active ingredient is an activated charcoal.

11. The filter device of claim 8, wherein the Pini Resina is dispersed in a porous substrate.

12. The filter device of claim 8, wherein the toxic compounds comprise benzene ring-containing compounds.

13. The filter device of claim 8, wherein the benzene ring-containing compounds comprise benzoic or phenolic compounds.

14. The filter device of claim 8 is a cigarette smoke filter, a mask, or an air cleaner.

15. The filter device of claim 8, wherein the gas is a cigarette smoke, exhaust from cars or motors or a toxic gas produced from a chemical reaction.

16. A process for preparing a filter device for removing toxic compounds from a gas, comprising the steps of:
(a) heating and dissolving Pini Resina to produce an oil product of Pini Resina;
(b) wetting a porous substrate with the oil product of Pini Resina;
(c) drying the porous substrate such that the oil product is dispersed on or in the porous substrate; and
(d) incorporating the porous substrate containing Pini Resina into a filter layer of the filter device.

17. The process of claim 16, wherein the Pini Resina is mixed with an activated charcoal.

18. A process for preparing a filter device for removing toxic compounds from a gas, comprising the steps of:
(a) heating and dissolving Pini Resina to produce an oil product of Pini Resina;
(b) mixing the oil product of Pini Resina with an activated charcoal to form a mixture;
(c) cooling the mixture at room temperature to form a solid;
(d) grinding the solid and incorporating the ground solid into a porous substrate to form a filter layer; and
(e) Fixing the filter layer to the filter device.

19. The process of claim 16, wherein the filter device is a cigarette filter, a mask or an air cleaner.

20. A process for removing toxic substances from a gas comprising the steps of (1) providing the filter device of claim 8 and (2) allowing a gas comprising toxic substances to pass through the filter layer of the filter device.

21. A process for removing toxic substances from a gas comprising the steps of (1) providing the filter device of claim 9 and (2) allowing a gas comprising toxic substances to pass through the filter layer of the filter device.
